(19) United States
(12) Patent Application Publication
(10) Pub. No.: US 2007/0267339 A1
(43) Pub. Date: Nov. 22, 2007

(54) Oil filter adapter

(76) Inventor: Myron L. Munn, Beatrice, NE (US)

Correspondence Address: THOMTE LAW OFFICE, L.L.C., 2120 S. 72ND STREET, SUITE 1111, OMAHA, NE, 68124, US

(21) Appl. No.: 10/829,005

(22) Filed: Apr. 21, 2004

(51) Int. Cl. B01D 27/00

(52) U.S. Cl. 210/450; 210/232; 123/196 A

(57) ABSTRACT

An oil filter adapter which is adapted to be secured to an oil filter receptacle of an automotive engine so that a larger oil filter may be substituted for a smaller factory oil filter thereby increasing the oil filtering capacity; the adapter allows mounting a larger oil filter, having mounting threads which are different from the factory oil filter mounting threads, to be secured to an internal combustion automotive engine.

### BACKGROUND OF THE INVENTION

1. Field of the Invention

This invention relates to an oil filter adapter and more particularly to an oil filter adapter which permits the use of a larger oil filter on internal combustion engines, thus increasing total oil capacity and total filtration media area for filtration of engine oil. The adapter permits the use of a larger oil filter with internal mounting threads which would otherwise be incompatible for mounting the larger filter on the oil filter receptacle nipple of the engine block.

2. Description of the Related Art

The capacity of the usual factory oil filter for a 2003 Ford F-350 pickup truck with a 6.8-liter 10-cylinder engine is approximately 525 milliliters. The capacity of the ACDelco oil filter number PF932 is approximately 1150 milliliters. Thus, the PF932 oil filter has a capacity of approximately 625 milliliters more than the factory Ford filter due to its greater length. Although the PF932 filter canister has the same diameter as the oil filter on the 2003 Ford truck described above, the filter canister O-ring or gasket on the PF932 filter has a greater diameter than the filter canister O-ring or gasket of the factory oil filter for the 2003 Ford F-350 pickup truck which means that the oil filter receptacle on the Ford truck will not accept the PF932 filter. Also, the external threads on the oil filter mounting nipple on the Ford truck are metric 22×1.5 mm threads. The internal mounting threads on the PF932 filter are 13/16—16 threads. Thus, it is physically impossible to utilize the larger capacity filter PF932 on the Ford truck described above due to the incompatibility of the canister gasket on the PF932 filter, and the incompatibility of the mounting threads, with respect to the oil filter receptacle of the Ford truck.

### SUMMARY OF THE INVENTION

An oil filter adapter is described for attachment to the filtered oil tube extending outwardly from an oil filter receptacle of an automotive engine such as the 2003 Ford F-350 pickup truck so that a larger capacity oil filter canister with different threads may be substituted for the standard smaller factory oil filter. The oil filter adapter of this invention comprises a disc-shaped member having an engine side and a filter side with the engine side of the disc-shaped member having an annular O-ring or gasket groove formed therein. An O-ring or gasket is mounted in the O-ring or gasket groove and is adapted to sealably engage the oil filter receptacle of the automotive engine. The disc-shaped member has an internally threaded central opening formed therein which extends inwardly thereinto from the engine side thereof which is adapted to threadably receive the filtered oil tube of the oil filter receptacle. The disc-shaped member has an externally threaded, hollow nipple extending from its filter side at the center thereof which is in fluid communication with the interior of the internally threaded central opening in the disc-shaped member. The disc-shaped member has a plurality of spaced-apart unfiltered oil passageways formed therein which extend therethrough from the engine side to the filter side. The filter side of the disc-shaped member has an annular seat formed thereon which is positioned outwardly of the unfiltered oil passageways and the hollow nipple. The internally threaded filtered oil outlet of the larger oil filter canister threadably receives the externally threaded hollow nipple whereby the canister O-ring or gasket of the larger filter may be drawn into sealing engagement with the annular seat on the filter side of the disc-shaped member. The canister O-ring or gasket of the larger filter canister has a larger diameter than the O-ring or gasket on the engine side of the disc-shaped member.

The adapter of this invention is used as follows. The smaller factory oil filter canister is removed from the oil filter receptacle on the automotive engine and the adapter of this invention is threadably mounted on the oil tube extending outwardly from the oil filter receptacle until the O-ring or gasket on the engine side of the adapter is brought into sealing engagement with the oil filter receptacle on the engine. The larger oil filter is then screwed onto the hollow nipple until the canister O-ring or gasket on the larger filter is drawn into sealing engagement with the annular seat on the filter side of the adapter.

It is therefore a principal object of the invention to provide an oil filter adapter which permits the use of a larger capacity oil filter to be positioned on an internal combustion engine rather than the smaller factory oil filter.

Yet another object of the invention is to provide an oil filter adapter which may be easily and conveniently mounted on the oil filter receptacle of an automotive engine without special tools.

Still another object of the invention is to provide an oil filter adapter of the type described above which enables the substitution of a larger capacity oil filter for a smaller oil filter which is normally utilized with an automotive engine.

These and other objects will be apparent to those skilled in the art.

### BRIEF DESCRIPTION OF THE DRAWINGS

FIG. 1 is a perspective view illustrating the smaller factory filter, the larger filter to be utilized, and the adapter of this invention prior to installation and after installation on the oil filter receptacle of the engine;

FIG. 2 is an exploded perspective view of the engine side of the adapter of this invention;

FIG. 3 is a perspective view of the filter side of the adapter of this invention;

FIG. 4 is a plan view of the engine side of the adapter of this invention;

FIG. 5 is a sectional view of the adapter of this invention;

FIG. 6 is a plan view of the filter side of the adapter of this invention;

FIG. 7 is a perspective view of the smaller oil filter which is to be replaced;

FIG. 8 is a plan view of one end of the filter of FIG. 7;

FIG. 9 is a perspective view of the larger oil filter which is to be substituted for the smaller filter of FIG. 7; and

FIG. 10 is a plan view of one end of the filter of FIG. 9.

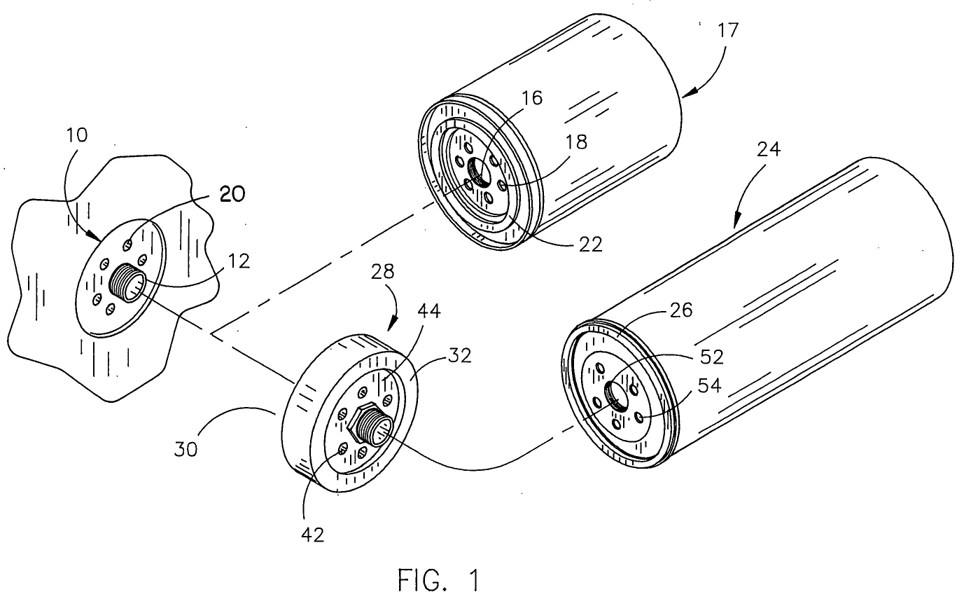

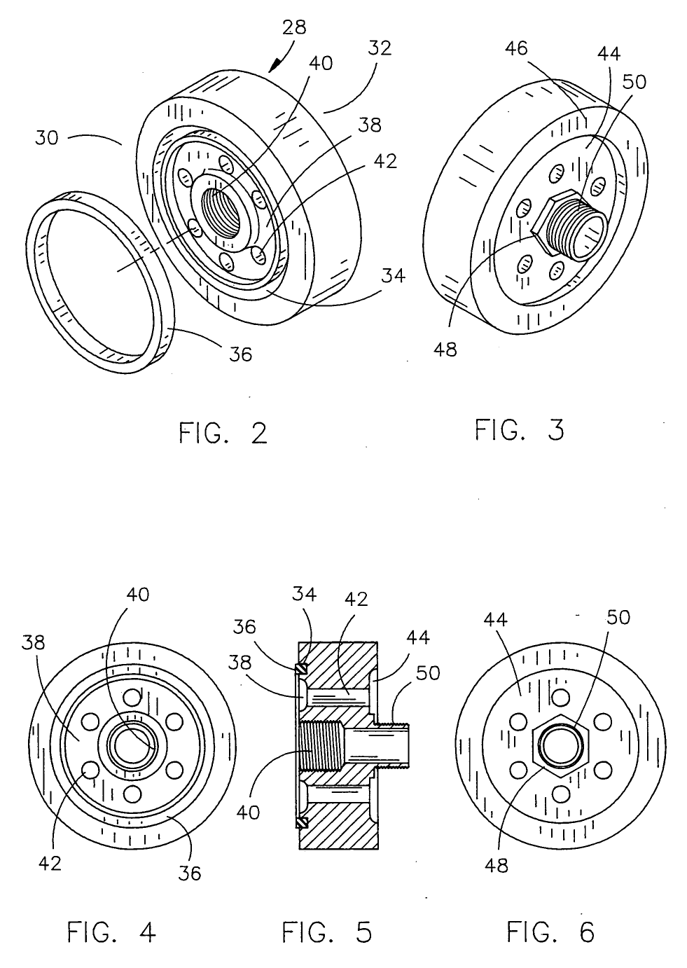

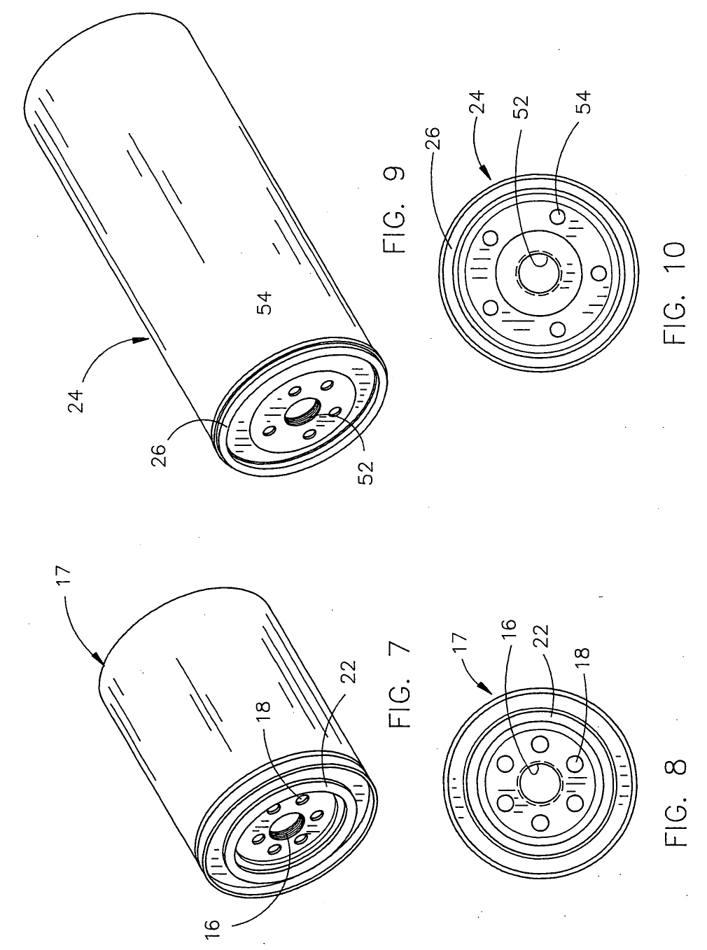

### DETAILED DESCRIPTION OF THE PREFERRED EMBODIMENT

The numeral 10 refers generally to an oil filter receptacle found on an automotive engine such as the 2003 Ford F-350 pickup truck with a 6.8-liter 10-cylinder engine. A filtered oil tube 12 extends outwardly from the receptacle 10 and is adapted to threadably receive the internally threaded filtered oil outlet 16 of the factory oil filter 17 for the 2003 Ford F-350 pickup truck with the 6.8-liter 10-cylinder engine as described above. The capacity of the factory filter 17 is approximately 525 milliliters. The open end of the filter 17 includes unfiltered oil passageways 18 which are in fluid communication with the unfiltered oil passageways 20 in the oil filter receptacle 10. The numeral 22 refers to the canister O-ring or gasket of the filter 17 which has a diameter compatible with the oil filter receptacle 10. The outside diameter of the canister O-ring or gasket on the oil filter for the above-described truck is 2.834 inches. The inside diameter of the canister O-ring or gasket on the oil filter for the above-described truck is 2.462 inches.

It is believed to be highly desirable to be able to mount an oil filter on the receptacle 10 which has a greater capacity than the 525-milliliter capacity of the standard factory oil filter 17. In the drawings, the numeral 24 refers to an ACDelco oil filter number PF932 which has approximately the same outside diameter as the Ford factory oil filter but which has a capacity of 1150 milliliters, 625 milliliters more than the factory Ford filter due to its increased length. The canister of the oil filter 24 has approximately the same outside diameter as the factory Ford filter but the canister O-ring or gasket 26 has a greater diameter than the canister O-ring or gasket 22 rendering it impossible, without an adapter, to utilize the ACDelco oil filter on the Ford truck. Also, the mounting threads on the factory filter 17 are metric threads (22×1.5 mm) whereas the mounting threads on the larger filter 24 are 13/16—16 threads. It is for that reason that applicant has designed the adapter generally referred to by the reference numeral 28 which enables the ACDelco oil filter number PF932 to be mounted on the oil filter receptacle 10 of the Ford truck described above. Preferably, the adapter 28 is machined from either steel or aluminum depending on the application. Adapter 28 is generally disc-shaped and preferably has a thickness of approximately 1.4 inches between its engine side 30 and its filter side 32 and has a diameter of approximately 3.67 inches which matches the diameter of the larger filter 24. Engine side 30 of adapter 28 is provided with a machined groove 34 which is preferably 0.145 inches deep. Into this groove is placed an elastomeric O-ring or gasket. The outside diameter of groove 34 is the same as the outside diameter of the canister O-ring or gasket 22 of the filter 17 so that the adapter 28 will be compatible with the oil filter receptacle 10. Gasket or O-ring 36 is positioned in groove 34 and protrudes a small amount from the engine side of the adapter 28. This O-ring or gasket allows for fluid-tight sealing of the adapter 28 against the receptacle 10 when the adapter 28 is screwed onto the engine oil tube 12 mounting threads. An annular recessed area 38 is milled in engine side 30 inwardly of groove 34, as seen in the drawings. Adapter 28 is provided with an internally threaded opening 40 which extends from the engine side 30 to the filter side 32. The diameter of the internally threaded opening 40, and the threads therein, are compatible with the oil tube 12 to enable the adapter 28 to be screwed onto the oil tube 12. A plurality of radially spaced unfiltered oil passageways 42 extend through the adapter 28 so that the inlet ends are positioned within the annular recessed area 38, as seen in the drawings.

The filter side of the adapter 28 is provided with an annular recessed area 44 which is spaced inwardly of the outer surface of the adapter 28 so as to define an annular seat 46. The annular recessed area 44 is milled so as to define a hex 48 which extends around the filter side of the externally threaded nipple 50. Nipple 50 extends from the filter side of adapter 28, as seen in the drawings. Nipple 50 has the same threads as the larger oil filter PF932 ( 13/16—16).

When it is desired to substitute the larger capacity filter 24 for the filter 17, the filter 17 is removed from the oil filter receptacle 10 by conventional means. The adapter 28 is secured to the oil filter receptacle 10 by rotating the adapter 28 clockwise so that the outer end of the oil tube 12 is threadably received by the engine side of the internally threaded opening 40. Adapter 28 is securely fastened to the receptacle 10 by a socket wrench, open end wrench or box end wrench until the O-ring or gasket 36 on the engine side of the adapter 28 is drawn into sealing engagement with the oil filter receptacle 10. Inasmuch as the O-ring or gasket 36 has the same outer diameter as the O-ring or gasket of the replaced filter 17, the adapter sealably engages the receptacle 10.

The filter 24 has an internally threaded filtered oil outlet 52 formed thereon which is screwed onto the nipple 50 with the same being easily accomplished through conventional means. The unfiltered oil passageways 54 on the filter 24 are in communication with the annular recessed area 44 so that unfiltered oil passing from the oil filter receptacle 10 through the passageways 42 will be in communication with the passageways 54. The tightening of the filter 24 onto the nipple 50 results in the O-ring or gasket 26 being drawn into sealing engagement with the annular seat 46.

A substitution of the larger filter 24 for the smaller filter 17 results in the amount of filtration media in the larger oil filter being more than 100% (more than double) the amount of filtration media in the smaller filter. The filtration area of a filter with 1150 milliliters of filtering capacity minus filtration area of a filter with 525 milliliters of capacity equals 625 milliliters of extra filtration capacity. This extra filtration capacity equals 625 divided by 525 equaling approximately 119% greater filtering capacity with the larger filter. In other words, with the adapter of this invention which enables the use of a larger oil filter, each time a given quantity of oil is circulated through the engine there is 119% more filtration media to clean the oil compared with the factory-sized oil filter which comes on the factory engine. The use of the adapter of this invention allows oil capacity of the engine to be increased because of the larger oil capacity of the oil filter 24. The use of a larger oil filter also greatly increases the filtration surface which the oil passes through, thus facilitating more efficient filtration of engine oil as described above.

Although the adapter is ideally suited wherein the ACDelco oil filter number PF932 is substituted for the factory oil filter for the 2003 Ford F-350 pickup truck, the adapter is also appropriate for all years of Ford pickups, vans, and medium to heavy duty trucks which come with engines using the same size and configuration of oil filter as used on the 2003 Ford F-350 pickup. The adapter will possibly accommodate other larger filters due to the annular seat 46 being able to accommodate O-rings or gaskets of slightly different outside diameters. The adapter would also be appropriate for other brands of engines (for example, Dodge pickups) by changing the diameter of the adapter 28 and adjusting the threading of the internally threaded central opening 40 on the engine side of the adapter to match the threads of the oil tube 12 found on engines used in Dodge pickup trucks, vans, and heavy trucks.

Further, there are some cases when oil coolers will be mounted on the oil filter receptacles 10 with the filter side of the oil cooler being identical to the oil filter receptacle 10. Thus, the adapter of this invention may also be secured to the filter side of an oil cooler rather than directly on the oil filter receptacle. Therefore, in the description above, when reference is made to the oil filter receptacle, it should be understood that reference is also made to the filter side of an oil cooler if the same is mounted on the oil filter receptacle.

It can therefore be seen that a novel oil filter adapter has been provided which enables the substitution of a smaller filter with a larger filter having different mounting threads, thereby achieving all of the stated objectives.

1. (canceled)

2. (canceled)

3. (canceled)

4. An oil filter adapter for attachment to the externally threaded filtered oil tube extending outwardly from an oil filter receptacle of an automotive engine which normally threadably receives the internally threaded filtered oil outlet at one end of a standard oil filter canister with the one end thereof having a canister O-ring or gasket provided thereon, the adapter enabling a replacement oil filter canister to be substituted for the standard oil filter canister with one end of the replacement oil filter canister having a canister O-ring or gasket provided thereon outwardly of an internally threaded filtered oil outlet, the standard and replacement oil filter canisters having substantially the same diameter with the replacement oil filter canister having a greater length than the standard oil filter canister to provide a greater filter capacity thereof, the replacement canister O-ring or gasket having a greater diameter than the standard canister O-ring or gasket, the oil filter adapter comprising:
a disc-shaped adapter member having an engine side and a filter side;
said engine side of said disc-shaped adapter member having an annular O-ring or gasket groove formed therein;
an O-ring or gasket positioned in said O-ring or gasket groove of said disc-shaped adapter member which is adapted to sealably engage the oil filter receptacle;
said O-ring or gasket positioned in said O-ring or gasket groove of said disc-shaped adapter member having the same diameter as said standard canister O-ring or gasket;
said disc-shaped adapter member having an internally threaded central opening formed therein which extends inwardly from said engine side thereof which is adapted to threadably receive the externally threaded filtered oil tube of the oil filter receptacle;
said disc-shaped adapter member having an externally threaded, hollow nipple extending from its said filter side at the center thereof which is in communication with the interior of said internally threaded central opening in said disc-shaped adapter member;
the threads of said hollow nipple matching the threads of the oil outlet of the replacement oil filter canister;
said disc-shaped adapter member having a plurality of spaced-apart unfiltered oil passageways formed therein which extend therethrough from said engine side to said filter side thereof outwardly of said central opening of said disc-shaped adapter member;
said filter side of said disc-shaped adapter member having an annular seat formed thereon which is positioned outwardly of said hollow nipple and said unfiltered oil passageway thereof;
the internally threaded filtered oil outlet of the replacement oil filter canister selectively threadably receiving said externally threaded hollow nipple whereby the canister O-ring or gasket of the replacement oil filter canister may be drawn into sealing engagement with said annular seat on said filter side of said disc-shaped adapter member.

5. (canceled)

6. The oil filter adapter of claim 4 wherein the threads of said internally threaded central opening of said disc-shaped adapter member are SAE threads and the threads of said hollow nipple are metric threads.

7. The oil filter adapter of claim 4 wherein said annular seat on said filter side of said disc-shaped adapter member has a width sufficiently large enough to enable replacement oil filter canister O-rings or gaskets of various diameters to be placed into sealing engagement therewith.

8. The oil filter adapter of claim 4 wherein said disc-shaped adapter member and said hollow nipple are of one-piece construction.
